(19) United States
(12) Patent Application Publication
(10) Pub. No.: US 2025/0247872 A1
(43) Pub. Date: Jul. 31, 2025

(54) CARRIER AGGREGATION FOR SIDELINK COMMUNICATION

(71) Applicant: Lenovo (Singapore) Pte. Limited, Singapore (SG)

(72) Inventors: Karthikeyan Ganesan, Kronberg Im Taunus (DE); Prateek Basu Mallick, Dreieich (DE); Joachim Löhr, Wiesbaden (DE); Ravi Kuchibhotla, Chicago, IL (US)

(73) Assignee: Lenovo (Singapore) Pte. Limited, Singapore (SG)

(21) Appl. No.: 18/855,878

(22) PCT Filed: Apr. 4, 2023
(86) PCT No.: PCT/IB2023/053417

§ 371 Date: Oct. 10, 2024

Related U.S. Application Data
(60) Provisional application No. 63/329,761, filed on Apr. 11, 2022.
(60) Provisional application No. 63/329,754, filed on Apr. 11, 2022.

(51) Int. Cl. H04W 72/40; H04L 5/00; H04W 72/0453; H04W 72/232

(52) U.S. Cl. CPC H04W 72/40; H04L 5/001; H04W 72/0453; H04W 72/232

(57) ABSTRACT

Various aspects of the present disclosure relate to implementations of CA for sidelink communication are described. Techniques are described for determining and configuring sidelink carrier frequencies for cross-carrier scheduling for sidelink CA communication. For instance, cell-specific and/or UE-specific scheduling of carrier frequencies for CA may be implemented. Implementations also enable sidelink HARQ reporting to wireless networks for providing indications of sidelink CA performance.

### RELATED APPLICATION

This application claims priority to U.S. Patent Application Ser. No. 63/329,754 filed 11 Apr. 2022 entitled “CARRIER AGGREGATION FOR SIDELINK COMMUNICATION,” and U.S. Patent Application Ser. No. 63/329,761 filed 11 Apr. 2022 entitled “CARRIER AGGREGATION FOR SIDELINK COMMUNICATION,” the disclosures of which are incorporated by reference herein in their entirety.

### TECHNICAL FIELD

The present disclosure relates to wireless communications, and more specifically to sidelink communication.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In addition to utilizing network infrastructure for wireless communications, UEs can utilize sidelink communications for direct device-to-device communication. Sidelink communication, for instance, enables UEs to exchange wireless signals directly between the devices, such as independent of a network infrastructure component, e.g., a base station.

### SUMMARY

Implementations of carrier aggregation (CA) for sidelink communication are described, such as related to methods, apparatuses, and systems that support CA for sidelink communication. Aspects of the disclosure, for instance, are directed to ways for determining and configuring sidelink carrier frequencies for cross-carrier scheduling for sidelink CA communication. For instance, cell-specific and/or UE-specific scheduling of carrier frequencies for CA may be implemented. Implementations also enable sidelink hybrid automatic repeat request (HARQ) reporting to wireless networks for providing indications of sidelink CA performance.

Accordingly, by enabling UEs to exchange CA capability information (e.g., primary carrier frequencies and secondary carrier frequencies) for sidelink communication, the described techniques enable UEs to quickly and efficiently obtain resources for sidelink CA, and to engage in CA for sidelink communication using allocated resources.

Some implementations of the method and apparatuses described herein may include wireless communication at a device (e.g., a UE), and the device determines, at a first UE sidelink carrier frequencies that are available to implement CA for sidelink communication; identifies from the sidelink carrier frequencies at least one primary sidelink carrier frequency and at least one secondary sidelink carrier frequency; and transmits data to a second UE using the at least one primary sidelink carrier frequency and the at least one secondary sidelink carrier frequency.

In some implementations of the method and apparatuses described herein, the sidelink carrier frequencies are identified based on one or more of cell-specific signaling received from a network node, UE-specific signaling received from a network node, or a pre-configuration of the UE; the sidelink carrier frequencies are configured in an ascending order of absolute radio-frequency channel number (ARFCN); further including receiving, from a network node, a mapping of one or more of the sidelink carrier frequencies to one or more service types that are operable to receive sidelink communication, where the mapping is based at least in part on priority information for the service types; further including determining the sidelink carrier frequencies based on an association of a serving cell of the UE to the sidelink carrier frequencies; where the association of the serving cell of the UE to the sidelink carrier frequencies is the same as an association of a primary cell of the UE to the sidelink carrier frequencies; further including: receiving signaling including one or more sidelink carrier frequencies associated with one or more synchronization signal blocks (SSBs); and receiving the one or more SSBs over the one or more sidelink carrier frequencies for synchronization of the at least one primary sidelink carrier frequency and the at least one secondary sidelink carrier frequency.

In some implementations of the method and apparatuses described herein, the one or more sidelink carrier frequencies associated with the one or more SSBs include the at least one primary sidelink carrier frequency; where the sidelink carrier frequencies are identified based on UE-specific signaling received from a network node, and where the UE-specific signaling, and where the UE-specific signaling includes one or more of: configuration for one or more sidelink synchronization carrier frequencies; one or more priority values for the sidelink carrier frequencies; or mapping information for mapping the sidelink carrier frequencies to the sidelink synchronization carrier frequencies; further including determining the sidelink carrier frequencies that are available to implement CA for sidelink communication based on signal transmission from the second UE; further including transmitting a broadcast identifying one or more of the sidelink carrier frequencies that are available to implement CA for sidelink communication; further including: generating HARQ feedback based on transmission over the at least one primary sidelink carrier frequency and the at least one secondary sidelink carrier frequency; and transmitting the sidelink HARQ to a network node; further including transmitting the sidelink HARQ along with downlink HARQ to the network node; further including transmitting the sidelink HARQ via a physical uplink control channel (PUCCH) field in downlink control information (DCI); further including transmitting the sidelink HARQ based on an ascending order of the at least one primary sidelink carrier frequency and the at least one secondary sidelink carrier frequency in a sidelink carrier frequency index.

Some implementations of the method and apparatuses described herein may include wireless communication at a device (e.g., a UE), and the device receives cross-carrier scheduling information including a scheduling physical downlink control channel (PDCCH) carrying scheduling for DCI received on a first carrier frequency with a first subcarrier spacing, and a physical sidelink shared channel (PSSCH) carrying scheduling for sidelink transmission to a second UE on a second carrier frequency with a second subcarrier spacing; and receives the PSSCH based on whether the first subcarrier is spacing is larger than or smaller than the second subcarrier spacing.

In some implementations of the method and apparatuses described herein, the first subcarrier spacing and the second subcarrier spacing include orthogonal frequency-division multiplexing (OFDM) spacings for the first carrier frequency and the second carrier frequency, respectively; where when the first subcarrier spacing is less than the second subcarrier spacing, the UE receives the PSSCH if a first symbol in the PSSCH allocation as defined by a time gap field in the DCI, and a first symbol of a slot of the PSSCH transmission start at least N PDCCH symbols after an end of the PDCCH scheduling of the PSSCH; further including determining whether the first symbol in the PSSCH allocation as defined by the time gap field in the DCI, and the first symbol of the slot of the PSSCH transmission start at least N PDCCH symbols after the end of the PDCCH scheduling of the PSSCH independent of a receive timing difference between a scheduling cell and the second carrier frequency; where the N PDCCH symbols are preconfigured in a table; where the time gap field includes a slot offset between the DCI and a start of the sidelink transmission; where the slot offset in the time gap field includes a slot offset representative of reference subcarrier spacing of one or more of a scheduling cell or the sidelink carrier.

In some implementations of the method and apparatuses described herein, the time gap field includes a difference in numerology between a scheduling cell and the sidelink carrier; where when the first subcarrier spacing is greater than the second subcarrier spacing, the UE receives the PSSCH if a first symbol in a PSSCH allocation as defined by a time gap field in the DCI starts no earlier than at least N PDCCH symbols after an end of the PDCCH scheduling the PSSCH; further including determining whether the first symbol in the PSSCH allocation as defined by the time gap field in the DCI starts no earlier than at least N PDCCH symbols after the end of the PDCCH scheduling the PSSCH independent of a receive timing difference between a scheduling cell and the second carrier frequency; where the N PDCCH symbols are preconfigured in a table; where the time gap field includes a slot offset between the DCI and a start of the sidelink transmission; where the slot offset in the time gap field includes a slot offset representative of reference subcarrier spacing of one or more of a scheduling cell or the sidelink carrier; where the time gap field includes a difference in numerology between a scheduling cell and the sidelink carrier.

Some implementations of the method and apparatuses described herein may include wireless communication at a device (e.g., a base station), and the device generates a notification of sidelink carrier frequencies that are available to implement CA for sidelink communication, the notification indicating at least one primary sidelink carrier frequency and at least one secondary sidelink carrier frequency; and transmits the notification to a UE.

In some implementations of the method and apparatuses described herein, the device generates the notification as one or more of cell-specific signaling or UE-specific signaling; where the notification identifies the sidelink carrier frequencies based on index values for the sidelink carrier frequencies in an index of sidelink carrier frequencies; where the notification identifies the sidelink carrier frequencies based on respective absolute radio-frequency channel numbers (ARFCNs) for the sidelink carrier frequencies; where the notification identifies a respective priority for one or more of the sidelink carrier frequencies; further including generating a definition of one or more serving cells of the network node that schedule the sidelink carrier frequencies by generating an association between the one or more serving cells and the sidelink carrier frequencies; where the definition of the one or more serving cells is the same as definition of a primary cell of the network node; further including generating a mapping table that associates serving cells of the network node with associated sidelink carrier frequencies, and where the mapping table defines each serving cell as a serving cell that schedules respective sidelink carrier frequencies using DCI; where the sidelink carrier frequencies include one or more sidelink carrier frequencies usable for transmitting or receiving a sidelink synchronization signal block (SSB); where the notification indicates that an SSB transmitted in a sidelink carrier frequency is usable for synchronization of a plurality of sidelink carrier frequencies, and at least one of the sidelink carrier frequencies is not usable for transmitting or receiving an SSB; where the notification includes an indication of priority for one or more of the sidelink carrier frequencies usable for transmitting or receiving an SSB; further including selecting one or more of the sidelink carrier frequencies usable for transmitting or receiving an SSB based on one or more of frequency or coverage of the one or more of the sidelink carrier frequencies; where at least one of the one or more of the sidelink carrier frequencies usable for transmitting or receiving an SSB includes the at least one primary sidelink carrier frequency.

In some implementations of the method and apparatuses described herein, the device generates the notification as UE-specific signaling to include DCI that includes one or more of a serving cell identifier mapped to the sidelink carrier frequencies, or a serving cell identifier for a serving cell that schedules the sidelink carrier frequencies; further including generating the notification as UE-specific signaling that indicates one or more of a synchronization sidelink carrier frequency, a priority of the synchronization sidelink carrier frequency, or mapping between the sidelink carrier frequencies and synchronization carrier frequency; where to generate the notification of the sidelink carrier frequencies, the device: configures a physical downlink control channel (PDCCH) in a serving cell to schedule sidelink transmission in the sidelink carrier frequencies; and configures the PDCCH to include a separate control resource set (CORESET), search space, and monitoring occasion to schedule DCI for each of the sidelink carrier frequencies; generates DCI that is usable to report HARQ feedback; transmits the DCI to the UE; and receives sidelink HARQ feedback from the UE based on transmission by the UE over the at least one primary sidelink carrier frequency and the at least one secondary sidelink carrier frequency; where the HARQ feedback is populatable to the DCI based on absence of a PUCCH cell indicator in the DCI; where a PUCCH cell designated for downlink HARQ reporting is implemented for transmitting the sidelink HARQ feedback; where a serving cell designated to monitor the DCI is implemented for transmitting the sidelink HARQ feedback.

Some implementations of the method and apparatuses described herein may include wireless communication at a device (e.g., a base station), and the device configures cross-carrier scheduling information including a physical downlink control channel (PDCCH) to schedule sidelink transmission for a plurality of sidelink carrier frequencies; and transmits the cross-carrier scheduling information to a UE.

In some implementations of the method and apparatuses described herein, the device, to configure the cross-carrier scheduling information, the device configures the PDCCH in a serving cell to schedule sidelink transmission in the sidelink carrier frequencies; and configures the PDCCH to include a separate control resource set (CORESET), search space, and monitoring occasion to schedule DCI for each of the sidelink carrier frequencies.

### BRIEF DESCRIPTION OF THE DRAWINGS

Various aspects of the present disclosure for CA for sidelink communication are described with reference to the following Figures. The same numbers may be used throughout to reference like features and components shown in the Figures.

FIG. 1 illustrates an example of a wireless communications system that supports CA for sidelink communication in accordance with aspects of the present disclosure.

FIG. 2 illustrates an example of a block diagram of a device (e.g., UE) that supports CA for sidelink communication in accordance with aspects of the present disclosure.

FIG. 3 illustrates an example of a block diagram of a device (e.g., a base station) that supports CA for sidelink communication in accordance with aspects of the present disclosure.

FIGS. 4-12 illustrate flowcharts of methods that support CA for sidelink communication in accordance with aspects of the present disclosure.

### DETAILED DESCRIPTION

Implementations of CA for sidelink communication are described, such as related to methods, apparatuses, and systems that support CA for sidelink communication. Aspects of the disclosure, for instance, are directed to ways for determining and configuring sidelink carrier frequencies for cross-carrier scheduling for sidelink CA communication. For instance, cell-specific and/or UE-specific scheduling of carrier frequencies for CA may be implemented. Implementations also enable sidelink HARQ reporting to wireless networks for providing indications of sidelink CA performance.

Accordingly, by enabling UEs to exchange CA capability information (e.g., primary carrier frequencies and secondary carrier frequencies) for sidelink communication, the described techniques enable UEs to quickly and efficiently obtain resources for sidelink CA, and to engage in CA for sidelink communication using allocated resources.

Aspects of the present disclosure are described in the context of a wireless communications system. Aspects of the present disclosure are further illustrated and described with reference to device diagrams and flowcharts that relate to CA for sidelink communication.

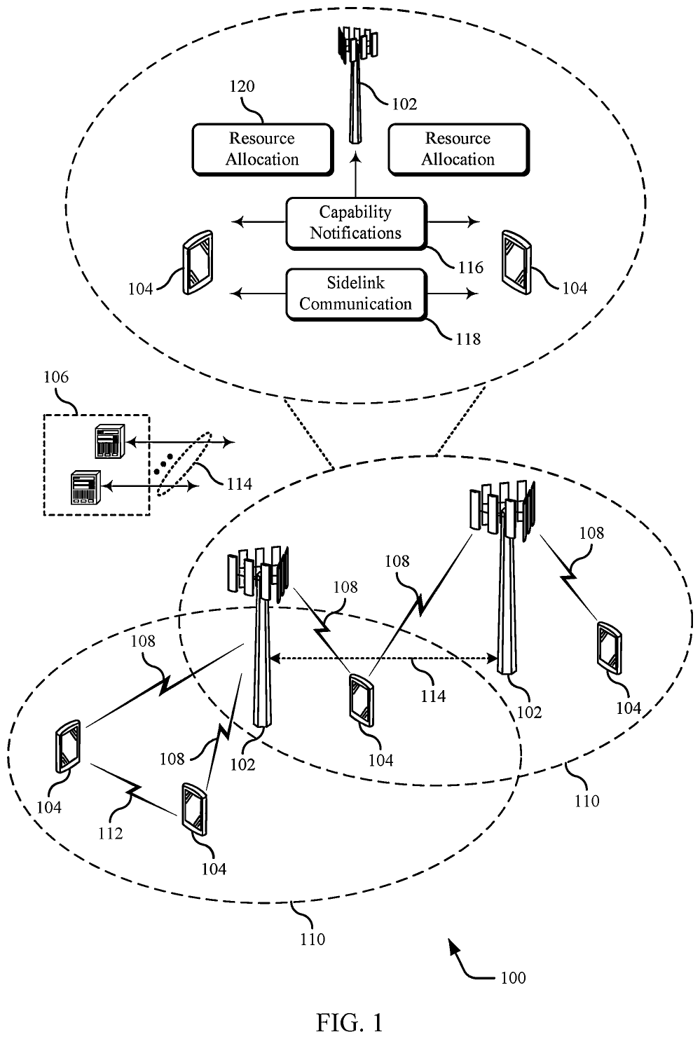

FIG. 1 illustrates an example of a wireless communications system 100 that supports CA for sidelink communication in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of CA for sidelink communication, as described herein. For instance, UEs 104 exchange capability notifications 116 that identify different sidelink capabilities of the UEs 104. Further, the UEs 104 communicate capability notifications 116 to base stations 102 to notify the base stations 102 and the wireless communications system 100 of sidelink capabilities of the UEs 104. Accordingly, based on sidelink capabilities of the UEs 104 the UEs 104 transmit data to one another as part of sidelink communication 118. The sidelink communication 118 can include various types of data such as voice data, video data, application data, coordination data, etc.

In at least some implementations, to enable the sidelink communication 118, base stations 102 communicate resource allocation 120 data to UEs 104. The resource allocation 120, for instance, includes resources that are usable by the UEs 104 to engage in the sidelink communication 118. Detailed examples of different capabilities and resources pertaining to sidelink communication are detailed throughout this disclosure.

In some wireless communications systems, sidelink communication has been developed in RAN to support V2X applications. Although NR sidelink was initially developed for V2X applications, there is growing interest to expand the applicability of NR sidelink to different use cases, such as public safety, commercial uses, and so forth. For commercial sidelink applications, two goals have been identified:
Increased sidelink data rate
Support of new carrier frequencies for sidelink

Increased sidelink data rate is motivated by applications such as sensor information (e.g., video) sharing between vehicles with high degree of driving automation. Increased data rate can be achieved with the support of sidelink CA and sidelink over unlicensed spectrum. CA is a technique wherein multiple frequency portions (component carriers) are assigned to a same UE. The maximum possible data rate per UE can be increased by increasing the number of component carriers towards the user. The system data rate of a cell increases as well because of a better resource utilization.

Furthermore, by enhancing the FR2 sidelink operation, increased data rate can be more efficiently supported on FR2. While the support of new carrier frequencies and larger bandwidths would also allow to improve its data rate, the main benefit would come from making sidelink more applicable for a wider range of applications. More specifically, with the support of unlicensed spectrum and the enhancement in frequency range 2 (FR2), sidelink can be implemented in commercial devices since utilization of the intelligent transportation systems (ITS) band is limited to ITS safety-related applications.

Some other objectives for expanding the applicability of sidelink in 5G NR include to specify mechanisms to support NR sidelink CA operation based on LTE sidelink CA operation [e.g., RAN2, RAN1, RAN4], and to support LTE sidelink CA features for NR, such as sidelink carrier (re-)selection, synchronization of aggregated carriers, handling limited capability, power control for simultaneous sidelink TX, packet duplication, etc.

Further, in some wireless communications systems, a UE can receive sidelink broadcast/groupcast transmissions with CA for the carrier on which it receives PSCCH/PSSCH and transmits the corresponding sidelink HARQ feedback, e.g., when SL-HARQ is enabled in SCI.

One of the biggest hurdles in configuring Sidelink CA is that unlike RAN Node in Uu, a sidelink UE device may not know the CA capability of its peer/group-member UEs. In Uu the network knows the UE's capability since it can query the UE for capability or receive them from the AMF, but in sidelink operation UEs may not know each other's aggregation capabilities especially for groupcast and broadcast-based SL communication, e.g., due to a lack of signaling connection establishment at least at the PC5 level. Further, for unicast SL communication, UE capabilities may only be shared when PC5 RRC Connection has been established between the peer UEs.

Still further, in some wireless communications systems, in sidelink the capability of a UE may keep “floating” since its activity keeps changing as peer UEs and groups and group-members it is linked to, connected to, and/or communicating with may change dynamically. This is due, for instance, to the dynamic nature of sidelink communication. As an example, a vehicle may need to communicate with a certain number of vehicles for lane changing at one point in time and to a different number of vehicles for see-through applications at a later point. Accordingly, this disclosure provides ways for allocating resources for sidelink CA and for implementing HARQ feedback for sidelink communications. Accordingly, aspects of CA for sidelink communication address concerns with some wireless communications systems by enabling UEs to obtain resources for CA sidelink, and to engage in CA for sidelink communication using allocated resources.

For instance, implementations enable determination and configuration of sidelink carrier frequency carrier index using cell-specific and UE-specific signaling. In implementations, a sidelink carrier index can be determined considering a plurality of sidelink carriers and signaling of sidelink carrier identifier and/or index values from gNB to UE and/or UE to gNB based on sidelink carrier identifiers, e.g., ARFCNs.

In implementations, cell-specific signaling of sidelink carrier index/identifiers maybe be provided by cell broadcast signaling that includes ARFCNs. Cell-specific signaling, for example, may indicate primary sidelink carrier(s) and secondary sidelink carrier(s). Sidelink carriers may be identified in ascending order of the ARFCNs of the sidelink carrier(s). In an example, mapping information of a priority of V2X service types and/or traffic profiles can be provided for sidelink carrier(s) configuration. Further, primary sidelink carrier(s) may be a default sidelink carrier(s) to transmit and receive discovery messages, such as for UEs with limited Tx/Rx RF chains.

In implementations, a definition of serving cell(s) scheduling sidelink carrier(s) may be provided by generating an association between the serving cell(s) of a gNB to that of the corresponding sidelink carrier(s). For instance, a serving cell(s) definition for scheduling sidelink carrier(s) may be same as that of the primary cell(s), e.g., PCell.

In an additional or alternative implementation, a mapping table for sidelink carrier frequencies can be created by associating serving cells of the gNB to that of plurality of sidelink carriers and serving cells may be defined as scheduling cells with corresponding sidelink carriers using DCI signaling. In implementations, sidelink carriers used for the reception of sidelink SSB transmission and reception may also be signaled. For instance, sidelink SSBs transmitted in a sidelink carrier may be used for synchronization of a plurality of sidelink carriers and some of the sidelink carriers may not be used for sidelink SSB transmission and/or reception, e.g., sidelink carriers for which UEs were not previously notified. UEs may be provided with a plurality of priorities for synchronization carriers and association of synchronization carriers with the sidelink carriers. In at least one implementation, synchronization carrier selection can be based on corresponding sidelink frequency and coverage.

In implementations, configuration is provided for cross-scheduling DCI scheduling of PSSCH transmission for a plurality of sidelink carriers. For instance, DCI is used for scheduling multiple sidelink carriers, and some sidelink carriers may not have a same numerology as Uu carriers. For instance, DCI (e.g., DCI format 3_0) which may be transmitted by a serving cell as described previously, and scheduling sidelink transmission in a plurality of sidelink carriers may contain sidelink carrier index identifiers and/or identifiers to associate a sidelink grant to that of a corresponding sidelink carrier. Further, sidelink carriers may have different numerologies and/or subcarrier spacings

In implementations, separate control resource sets (CORESETs), search spaces, and/or monitoring occasions maybe configured in serving cells as part of cross-carrier scheduling of corresponding sidelink transmissions to a plurality of sidelink carriers. In scenarios where limitations occur on DCI blind decoding on overlapping control channel elements (CCEs) from CORESETs and/or search spaces, a UE may decode scheduling grant in an order of priority corresponding to a priority of the sidelink carriers.

In implementations cross carrier scheduling PDCCH carrying scheduling DCI is received on one carrier with one orthogonal frequency division multiplexing (OFDM) subcarrier spacing (μPDCCH), and the PSSCH scheduled to a peer UE is received on another carrier with another OFDM subcarrier spacing (μPSSCH). In such scenarios, when μPDCCH<μPSSCH, a UE can receive a scheduled PSSCH when the first symbol in the PSSCH allocation as defined by the time gap field in the DCI and the first symbol of the slot of the PSSCH transmission starting at least Npssch PDCCH symbols after the end of the PDCCH scheduling the PSSCH. According to implementations this determination does not take into account the effect of receive timing difference between a scheduling cell and a sidelink carrier. Further, the Npssch PDCCH symbols maybe preconfigured in a table.

In scenarios where μPDCCH>μPSSCH, a UE can receive a scheduled PSSCH when a first symbol in the PSSCH allocation as defined by the time gap field in the DCI starts no earlier than at least Npssch PDCCH symbols after the end of the PDCCH scheduling the PSSCH. According to implementations this determination does not take into account an effect of receive timing difference between a scheduling cell and a sidelink carrier.

In implementations a time gap field value m (e.g., of the DCI format 3_0) provides an index m+1 into a slot offset table. The table is given by higher layer parameter sl-DCI-ToSL-Trans and the table value at index m+1 can be referred to as slot offset K_SL. The slot of the first sidelink transmission scheduled by the DCI is the first SL slot of the corresponding resource pool that starts not earlier than T_“DL”−T_“TA”/2+K_SL×T_“slot”, where T_“DL” is the starting time of the downlink slot carrying the corresponding DCI, T_“TA” is the timing advance value corresponding to the TAG of the serving cell on which the DCI is received, K_SL is the slot offset between the slot of the DCI and the first sidelink transmission scheduled by DCI, and T_slot is the sidelink slot duration.

In implementations, when PDCCH candidates are associated with a search space set configured with searchSpaceLinking, for the purpose of determining Npssch, a PDCCH candidate that ends later in time among two configured PDCCH candidates can be used. In implementations, the time gap field may contain a slot offset between the received DCI and the start of the sidelink transmission, and in scenarios where the cross-carrier scheduling with different subcarrier spacings between the scheduling cell and the sidelink carrier. The slot offset in the time gap field, for instance, could represent the slot offset in terms of reference subcarrier spacing which could be of either the scheduling cell or that of a sidelink carrier. Alternatively or additionally, the time gap may also include a gap for a difference in numerology between the scheduling cell and the sidelink carrier.

Implementations also enable sidelink HARQ reporting in PUCCH/PUSCH, and downlink HARQ and SL HARQ multiplexed together. For instance, a separate PUCCH cell indicator may be indicated in DCI in addition to a PUCCH resource indicator for reporting sidelink HARQ feedback to a gNB. Absence of the PUCCH cell indicator in the DCI, for example, means a PUCCH PCell could be used for the transmission of sidelink HARQ feedback to a gNB.

In additional or alternative implementations, a PUCCH cell selected for downlink HARQ reporting can be used for reporting sidelink HARQ feedback, e.g., to a gNB. In additional or alternative implementations, a serving cell that is configured to monitor DCI may be used for transmitting PUCCH. Further, an ascending order of a sidelink carrier index can be used for reporting sidelink HARQ from plurality of sidelink carriers, e.g., to a gNB.

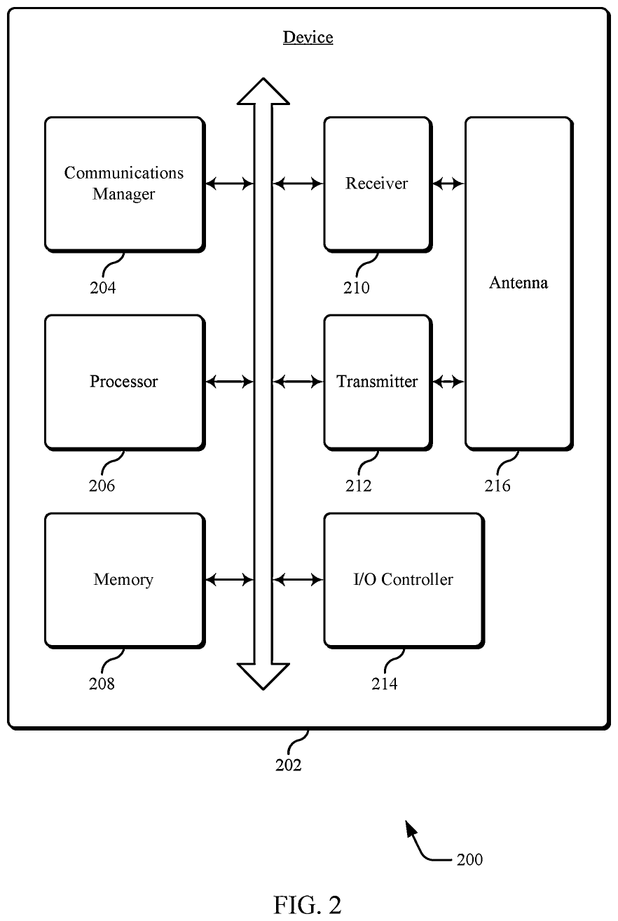

FIG. 2 illustrates an example of a block diagram 200 of a device 202 that supports CA for sidelink communication in accordance with aspects of the present disclosure. The device 202 may be an example of a UE 104 as described herein. The device 202 may support wireless communication and/or network signaling with one or more base stations 102, other UEs 104, network entities and devices, or any combination thereof. The device 202 may include components for bi-directional communications including components for transmitting and receiving communications, such as a communications manager 204, a processor 206, a memory 208, a receiver 210, a transmitter 212, and an I/O controller 214. These components may be in electronic communication or otherwise coupled (e.g., operatively, communicatively, functionally, electronically, electrically) via one or more interfaces (e.g., buses).

The communications manager 204, the receiver 210, the transmitter 212, or various combinations thereof or various components thereof may be examples of means for performing various aspects of the present disclosure as described herein. For example, the communications manager 204, the receiver 210, the transmitter 212, or various combinations or components thereof may support a method for performing one or more of the functions described herein.

In some implementations, the communications manager 204, the receiver 210, the transmitter 212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 206 and the memory 208 coupled with the processor 206 may be configured to perform one or more of the functions described herein (e.g., by executing, by the processor 206, instructions stored in the memory 208).

Additionally or alternatively, in some implementations, the communications manager 204, the receiver 210, the transmitter 212, or various combinations or components thereof may be implemented in code (e.g., as communications management software or firmware) executed by the processor 206. If implemented in code executed by the processor 206, the functions of the communications manager 204, the receiver 210, the transmitter 212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 204 may be configured to perform various operations (e.g., receiving, monitoring, transmitting) using or otherwise in cooperation with the receiver 210, the transmitter 212, or both. For example, the communications manager 204 may receive information from the receiver 210, send information to the transmitter 212, or be integrated in combination with the receiver 210, the transmitter 212, or both to receive information, transmit information, or perform various other operations as described herein. Although the communications manager 204 is illustrated as a separate component, in some implementations, one or more functions described with reference to the communications manager 204 may be supported by or performed by the processor 206, the memory 208, or any combination thereof. For example, the memory 208 may store code, which may include instructions executable by the processor 206 to cause the device 202 to perform various aspects of the present disclosure as described herein, or the processor 206 and the memory 208 may be otherwise configured to perform or support such operations.

For example, the communications manager 204 may support wireless communication and/or network signaling at a device (e.g., the device 202, a UE) in accordance with examples as disclosed herein.

The communications manager 204 and/or other device components may be configured as or otherwise support an apparatus, such as a UE, including a transceiver; a processor coupled to the transceiver, the processor and the transceiver configured to cause the apparatus to: determine sidelink carrier frequencies that are available to implement CA for sidelink communication; identify from the sidelink carrier frequencies at least one primary sidelink carrier frequency and at least one secondary sidelink carrier frequency; and transmit data to a second UE using the at least one primary sidelink carrier frequency and the at least one secondary sidelink carrier frequency.

Additionally, the apparatus (e.g., a UE) includes any one or combination of: where the sidelink carrier frequencies are identified based on one or more of cell-specific signaling received from a network node, UE-specific signaling received from a network node, or a pre-configuration of the UE; where the sidelink carrier frequencies are configured in an ascending order of ARFCN; where the processor and the transceiver are configured to cause the first UE to receive, from a network node, a mapping of one or more of the sidelink carrier frequencies to one or more service types that are operable to receive sidelink communication, where the mapping is based at least in part on priority information for the service types; where the processor and the transceiver are configured to cause the first UE to determine the sidelink carrier frequencies based on an association of a serving cell of the UE to the sidelink carrier frequencies; where the association of the serving cell of the UE to the sidelink carrier frequencies is the same as an association of a primary cell of the UE to the sidelink carrier frequencies; where the processor and the transceiver are configured to cause the first UE to: receive signaling including one or more sidelink carrier frequencies associated with one or more SSBs; and receive the one or more SSBs over the one or more sidelink carrier frequencies for synchronization of the at least one primary sidelink carrier frequency and the at least one secondary sidelink carrier frequency;

Additionally, the apparatus (e.g., a UE) includes any one or combination of: where the one or more sidelink carrier frequencies associated with the one or more SSBs include the at least one primary sidelink carrier frequency; where the sidelink carrier frequencies are identified based on UE-specific signaling received from a network node, and where the UE-specific signaling, and where the UE-specific signaling includes one or more of: configuration for one or more sidelink synchronization carrier frequencies; one or more priority values for the sidelink carrier frequencies; or mapping information for mapping the sidelink carrier frequencies to the sidelink synchronization carrier frequencies; where the processor and the transceiver are configured to cause the first UE to determine the sidelink carrier frequencies that are available to implement CA for sidelink communication based on signal transmission from the second UE; where the processor and the transceiver are configured to cause the first UE to transmit a broadcast identifying one or more of the sidelink carrier frequencies that are available to implement CA for sidelink communication; where the processor and the transceiver are configured to cause the first UE to: generate HARQ feedback based on transmission over the at least one primary sidelink carrier frequency and the at least one secondary sidelink carrier frequency; and transmit the sidelink HARQ to a network node; the processor and the transceiver are configured to cause the first UE to transmit the sidelink HARQ along with downlink HARQ to the network node; where the processor and the transceiver are configured to cause the first UE to transmit the sidelink HARQ via a PUCCH field in DCI; where the processor and the transceiver are configured to cause the first UE to transmit the sidelink HARQ based on an ascending order of the at least one primary sidelink carrier frequency and the at least one secondary sidelink carrier frequency in a sidelink carrier frequency index;

The communications manager 204 and/or other device components may be configured as or otherwise support a means for wireless communication and/or network signaling at a UE, including determining, at a first UE sidelink carrier frequencies that are available to implement CA for sidelink communication; identifying from the sidelink carrier frequencies at least one primary sidelink carrier frequency and at least one secondary sidelink carrier frequency; and transmitting data to a second UE using the at least one primary sidelink carrier frequency and the at least one secondary sidelink carrier frequency.

Additionally, wireless communication and/or network signaling at the UE includes any one or combination of: where the sidelink carrier frequencies are identified based on one or more of cell-specific signaling received from a network node, UE-specific signaling received from a network node, or a pre-configuration of the UE; where the sidelink carrier frequencies are configured in an ascending order of ARFCN; further including receiving, from a network node, a mapping of one or more of the sidelink carrier frequencies to one or more service types that are operable to receive sidelink communication, where the mapping is based at least in part on priority information for the service types; further including determining the sidelink carrier frequencies based on an association of a serving cell of the UE to the sidelink carrier frequencies; where the association of the serving cell of the UE to the sidelink carrier frequencies is the same as an association of a primary cell of the UE to the sidelink carrier frequencies; further including: receiving signaling including one or more sidelink carrier frequencies associated with one or more SSBs; and receiving the one or more SSBs over the one or more sidelink carrier frequencies for synchronization of the at least one primary sidelink carrier frequency and the at least one secondary sidelink carrier frequency.

Additionally, wireless communication and/or network signaling at the UE includes any one or combination of: where the one or more sidelink carrier frequencies associated with the one or more SSBs include the at least one primary sidelink carrier frequency; where the sidelink carrier frequencies are identified based on UE-specific signaling received from a network node, and where the UE-specific signaling, and where the UE-specific signaling includes one or more of: configuration for one or more sidelink synchronization carrier frequencies; one or more priority values for the sidelink carrier frequencies; or mapping information for mapping the sidelink carrier frequencies to the sidelink synchronization carrier frequencies; further including determining the sidelink carrier frequencies that are available to implement CA for sidelink communication based on signal transmission from the second UE; further including transmitting a broadcast identifying one or more of the sidelink carrier frequencies that are available to implement CA for sidelink communication; further including: generating HARQ feedback based on transmission over the at least one primary sidelink carrier frequency and the at least one secondary sidelink carrier frequency; and transmitting the sidelink HARQ to a network node; the method further including transmitting the sidelink HARQ along with downlink HARQ to the network node; further including transmitting the sidelink HARQ via a PUCCH field in DCI; further including transmitting the sidelink HARQ based on an ascending order of the at least one primary sidelink carrier frequency and the at least one secondary sidelink carrier frequency in a sidelink carrier frequency index.

The communications manager 204 and/or other device components may be configured as or otherwise support an apparatus, such as a UE, including a transceiver; a processor coupled to the transceiver, the processor and the transceiver configured to cause the apparatus to: receive cross-carrier scheduling information including a scheduling physical downlink control channel (PDCCH) carrying scheduling for DCI received on a first carrier frequency with a first subcarrier spacing, and a PSSCH carrying scheduling for sidelink transmission to a second UE on a second carrier frequency with a second subcarrier spacing; and receive the PSSCH based on whether the first subcarrier is spacing is larger than or smaller than the second subcarrier spacing.

Additionally, the apparatus (e.g., a UE) includes any one or combination of: where the first subcarrier spacing and the second subcarrier spacing include OFDM spacings for the first carrier frequency and the second carrier frequency, respectively; where when the first subcarrier spacing is less than the second subcarrier spacing, the UE receives the PSSCH if a first symbol in the PSSCH allocation as defined by a time gap field in the DCI, and a first symbol of a slot of the PSSCH transmission start at least N PDCCH symbols after an end of the PDCCH scheduling of the PSSCH; where the processor and the transceiver are configured to cause the first UE to determine whether the first symbol in the PSSCH allocation as defined by the time gap field in the DCI, and the first symbol of the slot of the PSSCH transmission start at least N PDCCH symbols after the end of the PDCCH scheduling of the PSSCH independent of a receive timing difference between a scheduling cell and the second carrier frequency.

Additionally, the apparatus (e.g., a UE) includes any one or combination of: where the N PDCCH symbols are preconfigured in a table; where the time gap field includes a slot offset between the DCI and a start of the sidelink transmission; where the slot offset in the time gap field includes a slot offset representative of reference subcarrier spacing of one or more of a scheduling cell or the sidelink carrier; where the time gap field includes a difference in numerology between a scheduling cell and the sidelink carrier; where when the first subcarrier spacing is greater than the second subcarrier spacing, the UE receives the PSSCH if a first symbol in a PSSCH allocation as defined by a time gap field in the DCI starts no earlier than at least N PDCCH symbols after an end of the PDCCH scheduling the PSSCH; where the processor and the transceiver are configured to cause the first UE to determine whether the first symbol in the PSSCH allocation as defined by the time gap field in the DCI starts no earlier than at least N PDCCH symbols after the end of the PDCCH scheduling the PSSCH independent of a receive timing difference between a scheduling cell and the second carrier frequency; where the N PDCCH symbols are preconfigured in a table; where the time gap field includes a slot offset between the DCI and a start of the sidelink transmission; where the slot offset in the time gap field includes a slot offset representative of reference subcarrier spacing of one or more of a scheduling cell or the sidelink carrier; where the time gap field includes a difference in numerology between a scheduling cell and the sidelink carrier;

The communications manager 204 and/or other device components may be configured as or otherwise support a means for wireless communication and/or network signaling at a UE, including receiving cross-carrier scheduling information including a scheduling physical downlink control channel (PDCCH) carrying scheduling for DCI received on a first carrier frequency with a first subcarrier spacing, and a PSSCH carrying scheduling for sidelink transmission to a second UE on a second carrier frequency with a second subcarrier spacing; and receiving the PSSCH based on whether the first subcarrier is spacing is larger than or smaller than the second subcarrier spacing.

Additionally, wireless communication and/or network signaling at the UE includes any one or combination of: where the first subcarrier spacing and the second subcarrier spacing include OFDM spacings for the first carrier frequency and the second carrier frequency, respectively; where when the first subcarrier spacing is less than the second subcarrier spacing, the UE receives the PSSCH if a first symbol in the PSSCH allocation as defined by a time gap field in the DCI, and a first symbol of a slot of the PSSCH transmission start at least N PDCCH symbols after an end of the PDCCH scheduling of the PSSCH; further including determining whether the first symbol in the PSSCH allocation as defined by the time gap field in the DCI, and the first symbol of the slot of the PSSCH transmission start at least N PDCCH symbols after the end of the PDCCH scheduling of the PSSCH independent of a receive timing difference between a scheduling cell and the second carrier frequency; where the N PDCCH symbols are preconfigured in a table; where the time gap field includes a slot offset between the DCI and a start of the sidelink transmission; where the slot offset in the time gap field includes a slot offset representative of reference subcarrier spacing of one or more of a scheduling cell or the sidelink carrier.

Additionally, wireless communication and/or network signaling at the UE includes any one or combination of: where the time gap field includes a difference in numerology between a scheduling cell and the sidelink carrier; where when the first subcarrier spacing is greater than the second subcarrier spacing, the UE receives the PSSCH if a first symbol in a PSSCH allocation as defined by a time gap field in the DCI starts no earlier than at least N PDCCH symbols after an end of the PDCCH scheduling the PSSCH; further including determining whether the first symbol in the PSSCH allocation as defined by the time gap field in the DCI starts no earlier than at least N PDCCH symbols after the end of the PDCCH scheduling the PSSCH independent of a receive timing difference between a scheduling cell and the second carrier frequency; where the N PDCCH symbols are preconfigured in a table; where the time gap field includes a slot offset between the DCI and a start of the sidelink transmission; where the slot offset in the time gap field includes a slot offset representative of reference subcarrier spacing of one or more of a scheduling cell or the sidelink carrier; where the time gap field includes a difference in numerology between a scheduling cell and the sidelink carrier.

The processor 206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 206 may be configured to operate a memory array using a memory controller. In some other implementations, a memory controller may be integrated into the processor 206. The processor 206 may be configured to execute computer-readable instructions stored in a memory (e.g., the memory 208) to cause the device 202 to perform various functions of the present disclosure.

The memory 208 may include random access memory (RAM) and read-only memory (ROM). The memory 208 may store computer-readable, computer-executable code including instructions that, when executed by the processor 206 cause the device 202 to perform various functions described herein. The code may be stored in a non-transitory computer-readable medium such as system memory or another type of memory. In some implementations, the code may not be directly executable by the processor 206 but may cause a computer (e.g., when compiled and executed) to perform functions described herein. In some implementations, the memory 208 may include, among other things, a basic I/O system (BIOS) which may control basic hardware or software operation such as the interaction with peripheral components or devices.

The I/O controller 214 may manage input and output signals for the device 202. The I/O controller 214 may also manage peripherals not integrated into the device 202. In some implementations, the I/O controller 214 may represent a physical connection or port to an external peripheral. In some implementations, the I/O controller 214 may utilize an operating system such as iOS®, ANDROID®, MS-DOS®, MS-WINDOWS®, OS/2®, UNIX®, LINUX®, or another known operating system. In some implementations, the I/O controller 214 may be implemented as part of a processor, such as the processor 206. In some implementations, a user may interact with the device 202 via the I/O controller 214 or via hardware components controlled by the I/O controller 214.

In some implementations, the device 202 may include a single antenna 216. However, in some other implementations, the device 202 may have more than one antenna 216, which may be capable of concurrently transmitting or receiving multiple wireless transmissions. The receiver 210 and the transmitter 212 may communicate bi-directionally, via the one or more antennas 216, wired, or wireless links as described herein. For example, the receiver 210 and the transmitter 212 may represent a wireless transceiver and may communicate bi-directionally with another wireless transceiver. The transceiver may also include a modem to modulate the packets, to provide the modulated packets to one or more antennas 216 for transmission, and to demodulate packets received from the one or more antennas 216.

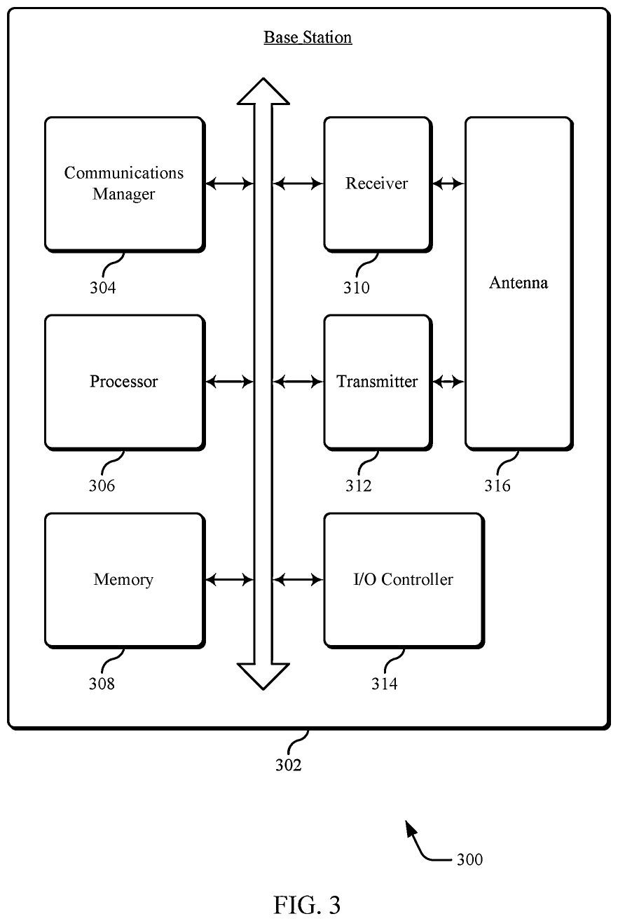

FIG. 3 illustrates an example of a block diagram 300 of a device 302 that supports CA for sidelink communication in accordance with aspects of the present disclosure. The device 302 may be an example of a base station 102, such as a gNB as described herein. The device 302 may support wireless communication and/or network signaling with one or more base stations 102, other UEs 104, core network devices and functions (e.g., core network 106), or any combination thereof. The device 302 may include components for bi-directional communications including components for transmitting and receiving communications, such as a communications manager 304, a processor 306, a memory 308, a receiver 310, a transmitter 312, and an I/O controller 314. These components may be in electronic communication or otherwise coupled (e.g., operatively, communicatively, functionally, electronically, electrically) via one or more interfaces (e.g., buses).

The communications manager 304, the receiver 310, the transmitter 312, or various combinations thereof or various components thereof may be examples of means for performing various aspects of the present disclosure as described herein. For example, the communications manager 304, the receiver 310, the transmitter 312, or various combinations or components thereof may support a method for performing one or more of the functions described herein.

In some implementations, the communications manager 304, the receiver 310, the transmitter 312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 306 and the memory 308 coupled with the processor 306 may be configured to perform one or more of the functions described herein (e.g., by executing, by the processor 306, instructions stored in the memory 308).

Additionally or alternatively, in some implementations, the communications manager 304, the receiver 310, the transmitter 312, or various combinations or components thereof may be implemented in code (e.g., as communications management software or firmware) executed by the processor 306. If implemented in code executed by the processor 306, the functions of the communications manager 304, the receiver 310, the transmitter 312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 304 may be configured to perform various operations (e.g., receiving, monitoring, transmitting) using or otherwise in cooperation with the receiver 310, the transmitter 312, or both. For example, the communications manager 304 may receive information from the receiver 310, send information to the transmitter 312, or be integrated in combination with the receiver 310, the transmitter 312, or both to receive information, transmit information, or perform various other operations as described herein. Although the communications manager 304 is illustrated as a separate component, in some implementations, one or more functions described with reference to the communications manager 304 may be supported by or performed by the processor 306, the memory 308, or any combination thereof. For example, the memory 308 may store code, which may include instructions executable by the processor 306 to cause the device 302 to perform various aspects of the present disclosure as described herein, or the processor 306 and the memory 308 may be otherwise configured to perform or support such operations.

For example, the communications manager 304 may support wireless communication and/or network signaling at a device (e.g., the device 302, a base station) in accordance with examples as disclosed herein. The communications manager 304 and/or other device components may be configured as or otherwise support an apparatus, such as a base station, including a transceiver; a processor coupled to the transceiver, the processor and the transceiver configured to cause the apparatus to: generate a notification of sidelink carrier frequencies that are available to implement CA for sidelink communication, the notification indicating at least one primary sidelink carrier frequency and at least one secondary sidelink carrier frequency; and transmit the notification to a UE.

Additionally, the apparatus (e.g., a base station) includes any one or combination of: where the processor and the transceiver are configured to cause the network node to generate the notification as one or more of cell-specific signaling or UE-specific signaling; where the notification identifies the sidelink carrier frequencies based on index values for the sidelink carrier frequencies in an index of sidelink carrier frequencies; where the notification identifies the sidelink carrier frequencies based on respective absolute radio-frequency channel numbers (ARFCNs) for the sidelink carrier frequencies; where the notification identifies a respective priority for one or more of the sidelink carrier frequencies; where the processor and the transceiver are configured to cause the network node to generate a definition of one or more serving cells of the network node that schedule the sidelink carrier frequencies by generating an association between the one or more serving cells and the sidelink carrier frequencies; where the definition of the one or more serving cells is the same as definition of a primary cell of the network node; where the processor and the transceiver are configured to cause the network node to generate a mapping table that associates serving cells of the network node with associated sidelink carrier frequencies, and where the mapping table defines each serving cell as a serving cell that schedules respective sidelink carrier frequencies using DCI; where the sidelink carrier frequencies include one or more sidelink carrier frequencies usable for transmitting or receiving a sidelink synchronization signal block (SSB); where the notification indicates that an SSB transmitted in a sidelink carrier frequency is usable for synchronization of a plurality of sidelink carrier frequencies. and at least one of the sidelink carrier frequencies is not usable for transmitting or receiving an SSB; where the notification includes an indication of priority for one or more of the sidelink carrier frequencies usable for transmitting or receiving an SSB; where the processor and the transceiver are configured to cause the network node to select one or more of the sidelink carrier frequencies usable for transmitting or receiving an SSB based on one or more of frequency or coverage of the one or more of the sidelink carrier frequencies; where at least one of the one or more of the sidelink carrier frequencies usable for transmitting or receiving an SSB includes the at least one primary sidelink carrier frequency;

Additionally, the apparatus (e.g., a base station) includes any one or combination of: where the processor and the transceiver are configured to cause the network node to generate the notification as UE-specific signaling that includes DCI that includes one or more of a serving cell identifier mapped to the sidelink carrier frequencies, or a serving cell identifier for a serving cell that schedules the sidelink carrier frequencies; where the processor and the transceiver are configured to cause the network node to generate the notification as UE-specific signaling that indicates one or more of a synchronization sidelink carrier frequency, a priority of the synchronization sidelink carrier frequency, or mapping between the sidelink carrier frequencies and synchronization carrier frequency; where to generate the notification of the sidelink carrier frequencies, the processor and the transceiver are configured to cause the network node to: configure a physical downlink control channel (PDCCH) in a serving cell to schedule sidelink transmission in the sidelink carrier frequencies; and configure the PDCCH to include a separate control resource set (CORESET), search space, and monitoring occasion to schedule DCI for each of the sidelink carrier frequencies; where the processor and the transceiver are configured to cause the network node to: generate DCI that is usable to report HARQ feedback; transmit the DCI to the UE; and receive sidelink HARQ feedback from the UE based on transmission by the UE over the at least one primary sidelink carrier frequency and the at least one secondary sidelink carrier frequency; where the HARQ feedback is populatable to the DCI based on absence of a PUCCH cell indicator in the DCI; where a PUCCH cell designated for downlink HARQ reporting is implemented for transmitting the sidelink HARQ feedback; where a serving cell designated to monitor the DCI is implemented for transmitting the sidelink HARQ feedback;

The communications manager 304 and/or other device components may be configured as or otherwise support a means for wireless communication and/or network signaling at a base station, including generating a notification of sidelink carrier frequencies that are available to implement CA for sidelink communication, the notification indicating at least one primary sidelink carrier frequency and at least one secondary sidelink carrier frequency; and transmitting the notification to a UE.

Additionally, wireless communication at the base station includes any one or combination of: further including generating the notification as one or more of cell-specific signaling or UE-specific signaling; where the notification identifies the sidelink carrier frequencies based on index values for the sidelink carrier frequencies in an index of sidelink carrier frequencies; where the notification identifies the sidelink carrier frequencies based on respective absolute radio-frequency channel numbers (ARFCNs) for the sidelink carrier frequencies; where the notification identifies a respective priority for one or more of the sidelink carrier frequencies; further including generating a definition of one or more serving cells of the network node that schedule the sidelink carrier frequencies by generating an association between the one or more serving cells and the sidelink carrier frequencies; where the definition of the one or more serving cells is the same as definition of a primary cell of the network node; further including generating a mapping table that associates serving cells of the network node with associated sidelink carrier frequencies, and where the mapping table defines each serving cell as a serving cell that schedules respective sidelink carrier frequencies using DCI; where the sidelink carrier frequencies include one or more sidelink carrier frequencies usable for transmitting or receiving a sidelink synchronization signal block (SSB); where the notification indicates that an SSB transmitted in a sidelink carrier frequency is usable for synchronization of a plurality of sidelink carrier frequencies, and at least one of the sidelink carrier frequencies is not usable for transmitting or receiving an SSB; where the notification includes an indication of priority for one or more of the sidelink carrier frequencies usable for transmitting or receiving an SSB; further including selecting one or more of the sidelink carrier frequencies usable for transmitting or receiving an SSB based on one or more of frequency or coverage of the one or more of the sidelink carrier frequencies; where at least one of the one or more of the sidelink carrier frequencies usable for transmitting or receiving an SSB includes the at least one primary sidelink carrier frequency.

Additionally, wireless communication at the base station includes any one or combination of: further including generating the notification as UE-specific signaling that includes DCI that includes one or more of a serving cell identifier mapped to the sidelink carrier frequencies, or a serving cell identifier for a serving cell that schedules the sidelink carrier frequencies; further including generating the notification as UE-specific signaling that indicates one or more of a synchronization sidelink carrier frequency, a priority of the synchronization sidelink carrier frequency, or mapping between the sidelink carrier frequencies and synchronization carrier frequency; where to generate the notification of the sidelink carrier frequencies, the method further includes: configuring a physical downlink control channel (PDCCH) in a serving cell to schedule sidelink transmission in the sidelink carrier frequencies; and configuring the PDCCH to include a separate control resource set (CORESET), search space, and monitoring occasion to schedule DCI for each of the sidelink carrier frequencies; further including: generating DCI that is usable to report HARQ feedback; transmitting the DCI to the UE; and receiving sidelink HARQ feedback from the UE based on transmission by the UE over the at least one primary sidelink carrier frequency and the at least one secondary sidelink carrier frequency; where the HARQ feedback is populatable to the DCI based on absence of a PUCCH cell indicator in the DCI; where a PUCCH cell designated for downlink HARQ reporting is implemented for transmitting the sidelink HARQ feedback; where a serving cell designated to monitor the DCI is implemented for transmitting the sidelink HARQ feedback.

The communications manager 304 and/or other device components may be configured as or otherwise support an apparatus, such as a base station, including a transceiver; a processor coupled to the transceiver, the processor and the transceiver configured to cause the apparatus to: configure cross-carrier scheduling information including a physical downlink control channel (PDCCH) to schedule sidelink transmission for a plurality of sidelink carrier frequencies; and transmit the cross-carrier scheduling information to a UE.

Additionally, the apparatus (e.g., a base station) includes any one or combination of: configure the PDCCH in a serving cell to schedule sidelink transmission in the sidelink carrier frequencies; and configure the PDCCH to include a separate control resource set (CORESET), search space, and monitoring occasion to schedule DCI for each of the sidelink carrier frequencies.

The communications manager 304 and/or other device components may be configured as or otherwise support a means for wireless communication and/or network signaling at a base station, including configuring cross-carrier scheduling information including a physical downlink control channel (PDCCH) to schedule sidelink transmission for a plurality of sidelink carrier frequencies; and transmitting the cross-carrier scheduling information to a UE.

Additionally, wireless communication at the base station includes any one or combination of: where to configure the cross-carrier scheduling information, the method further includes: configuring the PDCCH in a serving cell to schedule sidelink transmission in the sidelink carrier frequencies; and configuring the PDCCH to include a separate control resource set (CORESET), search space, and monitoring occasion to schedule DCI for each of the sidelink carrier frequencies.

The processor 306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 306 may be configured to operate a memory array using a memory controller. In some other implementations, a memory controller may be integrated into the processor 306. The processor 306 may be configured to execute computer-readable instructions stored in a memory (e.g., the memory 308) to cause the device 302 to perform various functions of the present disclosure.

The memory 308 may include random access memory (RAM) and read-only memory (ROM). The memory 308 may store computer-readable, computer-executable code including instructions that, when executed by the processor 306 cause the device 302 to perform various functions described herein. The code may be stored in a non-transitory computer-readable medium such as system memory or another type of memory. In some implementations, the code may not be directly executable by the processor 306 but may cause a computer (e.g., when compiled and executed) to perform functions described herein. In some implementations, the memory 308 may include, among other things, a basic I/O system (BIOS) which may control basic hardware or software operation such as the interaction with peripheral components or devices.

The I/O controller 314 may manage input and output signals for the device 302. The I/O controller 314 may also manage peripherals not integrated into the device 302. In some implementations, the I/O controller 314 may represent a physical connection or port to an external peripheral. In some implementations, the I/O controller 314 may utilize an operating system such as iOS®, ANDROID®, MS-DOS®, MS-WINDOWS®, OS/2®, UNIX®, LINUX®, or another known operating system. In some implementations, the I/O controller 314 may be implemented as part of a processor, such as the processor 306. In some implementations, a user may interact with the device 302 via the I/O controller 314 or via hardware components controlled by the I/O controller 314.

In some implementations, the device 302 may include a single antenna 316. However, in some other implementations, the device 302 may have more than one antenna 316, which may be capable of concurrently transmitting or receiving multiple wireless transmissions. The receiver 310 and the transmitter 312 may communicate bi-directionally, via the one or more antennas 316, wired, or wireless links as described herein. For example, the receiver 310 and the transmitter 312 may represent a wireless transceiver and may communicate bi-directionally with another wireless transceiver. The transceiver may also include a modem to modulate the packets, to provide the modulated packets to one or more antennas 316 for transmission, and to demodulate packets received from the one or more antennas 316.

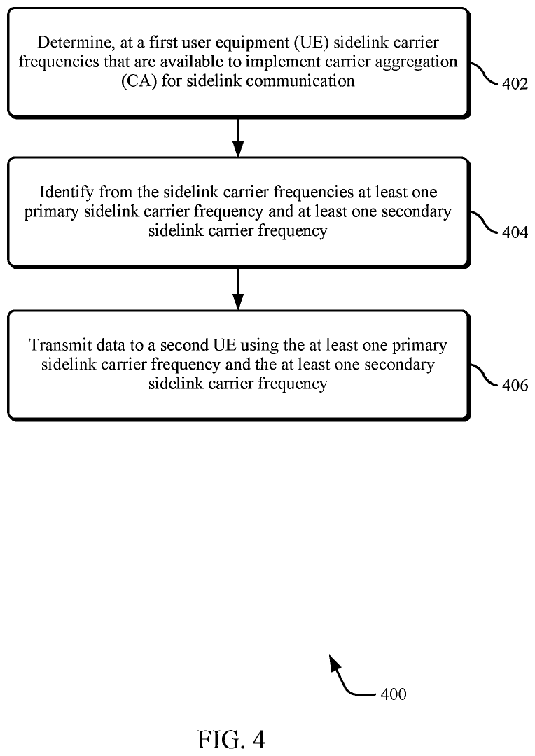

FIG. 4 illustrates a flowchart of a method 400 that supports CA for sidelink communication in accordance with aspects of the present disclosure. The operations of the method 400 may be implemented and performed by a device or its components, such as a UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 402, the method may include determining, at a first UE sidelink carrier frequencies that are available to implement CA for sidelink communication. The operations of 402 may be performed in accordance with examples as described herein. In some implementations, aspects of the operations of 402 may be performed by a device as described with reference to FIG. 1.

At 404, the method may include identifying from the sidelink carrier frequencies at least one primary sidelink carrier frequency and at least one secondary sidelink carrier frequency. The operations of 404 may be performed in accordance with examples as described herein. In some implementations, aspects of the operations of 404 may be performed by a device as described with reference to FIG. 1.

At 406, the method may include transmitting data to a second UE using the at least one primary sidelink carrier frequency and the at least one secondary sidelink carrier frequency. The operations of 406 may be performed in accordance with examples as described herein. In some implementations, aspects of the operations of 406 may be performed by a device as described with reference to FIG. 1.

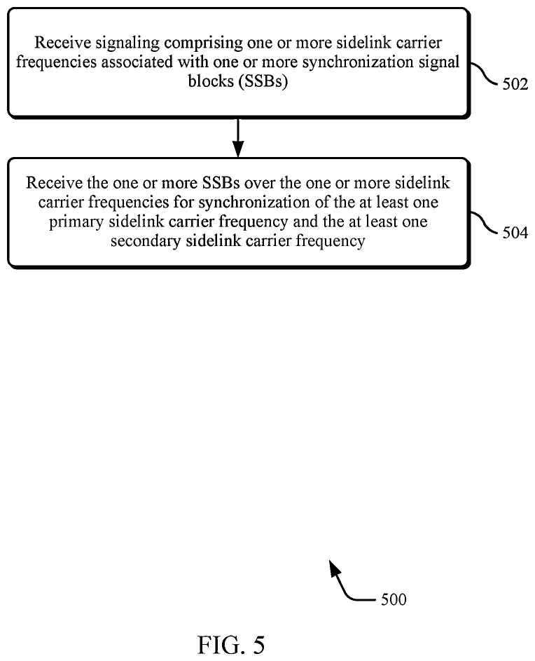

FIG. 5 illustrates a flowchart of a method 500 that supports CA for sidelink communication in accordance with aspects of the present disclosure. The operations of the method 500 may be implemented and performed by a device or its components, such as a UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 502, the method may include receiving signaling comprising one or more sidelink carrier frequencies associated with one or more SSBs. The operations of 502 may be performed in accordance with examples as described herein. In some implementations, aspects of the operations of 502 may be performed by a device as described with reference to FIG. 1.

At 504, the method may include receiving the one or more SSBs over the one or more sidelink carrier frequencies for synchronization of the at least one primary sidelink carrier frequency and the at least one secondary sidelink carrier frequency. The operations of 504 may be performed in accordance with examples as described herein. In some implementations, aspects of the operations of 504 may be performed by a device as described with reference to FIG. 1.

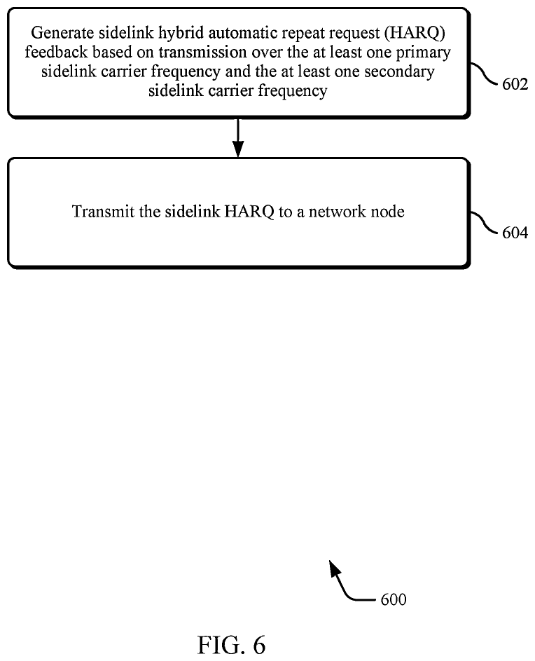

FIG. 6 illustrates a flowchart of a method 600 that supports CA for sidelink communication in accordance with aspects of the present disclosure. The operations of the method 600 may be implemented and performed by a device or its components, such as a UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 602, the method may include generating HARQ feedback based on transmission over the at least one primary sidelink carrier frequency and the at least one secondary sidelink carrier frequency. The operations of 602 may be performed in accordance with examples as described herein. In some implementations, aspects of the operations of 602 may be performed by a device as described with reference to FIG. 1.

At 604, the method may include transmitting the sidelink HARQ to a network node. The operations of 604 may be performed in accordance with examples as described herein. In some implementations, aspects of the operations of 604 may be performed by a device as described with reference to FIG. 1.

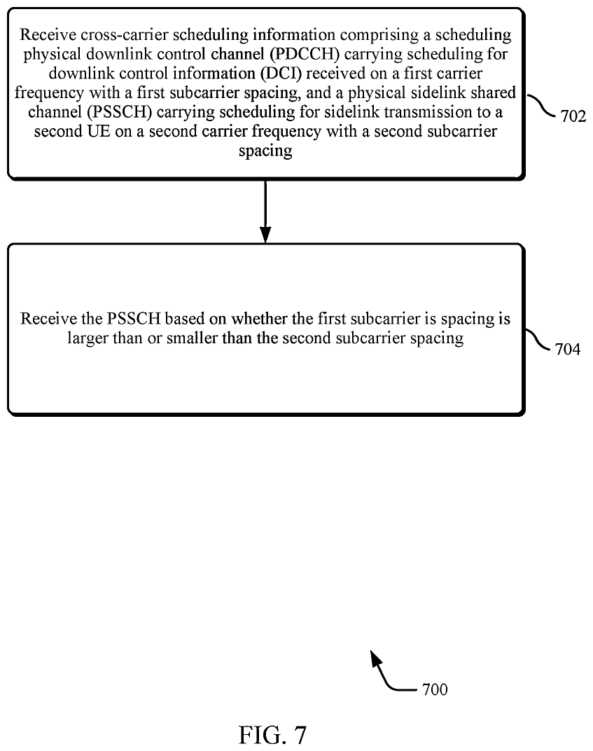

FIG. 7 illustrates a flowchart of a method 700 that supports CA for sidelink communication in accordance with aspects of the present disclosure. The operations of the method 700 may be implemented and performed by a device or its components, such as a UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 702, the method may include receiving cross-carrier scheduling information comprising a scheduling physical downlink control channel (PDCCH) carrying scheduling for DCI received on a first carrier frequency with a first subcarrier spacing, and a PSSCH carrying scheduling for sidelink transmission to a second UE on a second carrier frequency with a second subcarrier spacing. The operations of 702 may be performed in accordance with examples as described herein. In some implementations, aspects of the operations of 702 may be performed by a device as described with reference to FIG. 1.

At 704, the method may include receiving the PSSCH based on whether the first subcarrier is spacing is larger than or smaller than the second subcarrier spacing. The operations of 704 may be performed in accordance with examples as described herein. In some implementations, aspects of the operations of 704 may be performed by a device as described with reference to FIG. 1.

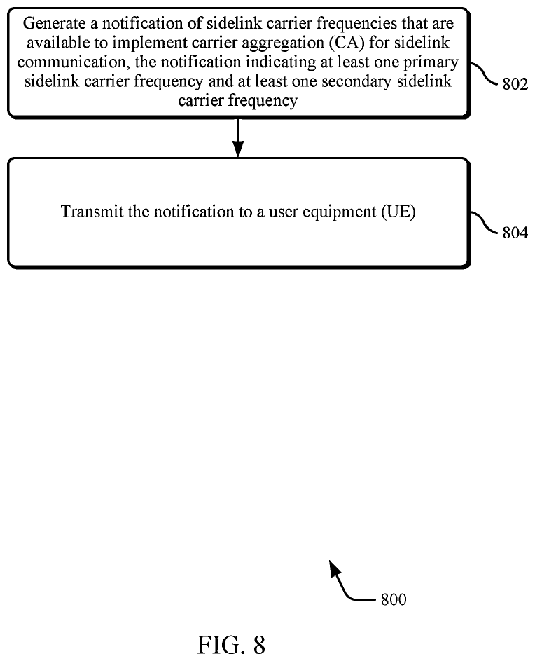

FIG. 8 illustrates a flowchart of a method 800 that supports CA for sidelink communication in accordance with aspects of the present disclosure. The operations of the method 800 may be implemented and performed by a device or its components, such as a base station 102, e.g., gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 802, the method may include generating a notification of sidelink carrier frequencies that are available to implement CA for sidelink communication, the notification indicating at least one primary sidelink carrier frequency and at least one secondary sidelink carrier frequency. The operations of 802 may be performed in accordance with examples as described herein. In some implementations, aspects of the operations of 802 may be performed by a device as described with reference to FIG. 1.

At 804, the method may include transmitting the notification to a UE. The operations of 804 may be performed in accordance with examples as described herein. In some implementations, aspects of the operations of 804 may be performed by a device as described with reference to FIG. 1.

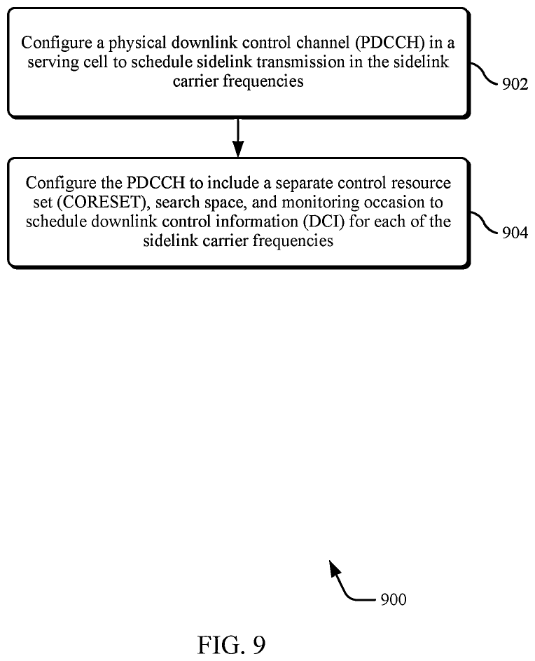

FIG. 9 illustrates a flowchart of a method 900 that supports CA for sidelink communication in accordance with aspects of the present disclosure. The operations of the method 900 may be implemented and performed by a device or its components, such as a base station 102, e.g., gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 902, the method may include configuring a physical downlink control channel (PDCCH) in a serving cell to schedule sidelink transmission in the sidelink carrier frequencies. The operations of 902 may be performed in accordance with examples as described herein. In some implementations, aspects of the operations of 902 may be performed by a device as described with reference to FIG. 1.

At 904, the method may include configuring the PDCCH to include a separate control resource set (CORESET), search space, and monitoring occasion to schedule DCI for each of the sidelink carrier frequencies. The operations of 904 may be performed in accordance with examples as described herein. In some implementations, aspects of the operations of 904 may be performed by a device as described with reference to FIG. 1.

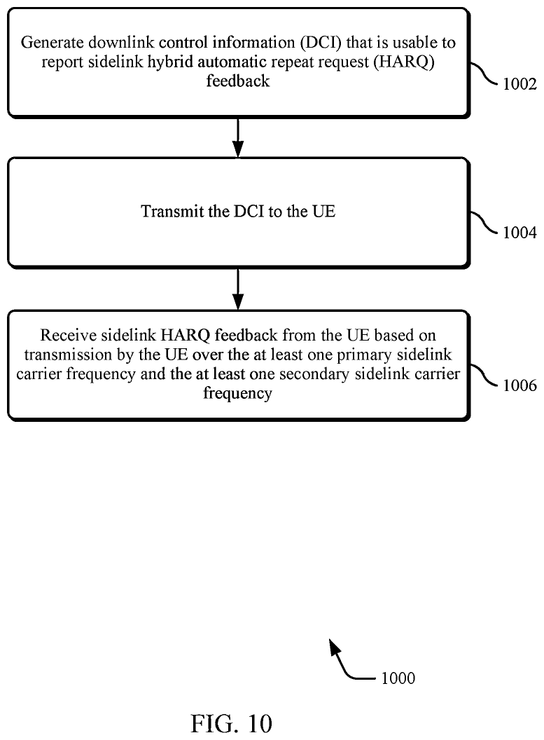

FIG. 10 illustrates a flowchart of a method 1000 that supports CA for sidelink communication in accordance with aspects of the present disclosure. The operations of the method 1000 may be implemented and performed by a device or its components, such as a base station 102, e.g., gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 1002, the method may include generating DCI that is usable to report HARQ feedback. The operations of 1002 may be performed in accordance with examples as described herein. In some implementations, aspects of the operations of 1002 may be performed by a device as described with reference to FIG. 1.

At 1004, the method may include transmitting the DCI to the UE. The operations of 1004 may be performed in accordance with examples as described herein. In some implementations, aspects of the operations of 1004 may be performed by a device as described with reference to FIG. 1.

At 1006, the method may include receiving sidelink HARQ feedback from the UE based on transmission by the UE over the at least one primary sidelink carrier frequency and the at least one secondary sidelink carrier frequency. The operations of 1006 may be performed in accordance with examples as described herein. In some implementations, aspects of the operations of 1006 may be performed by a device as described with reference to FIG. 1.

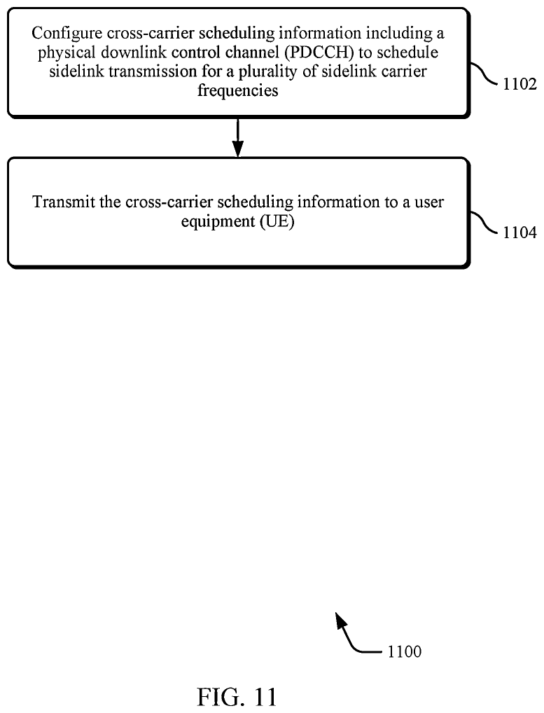

FIG. 11 illustrates a flowchart of a method 1100 that supports CA for sidelink communication in accordance with aspects of the present disclosure. The operations of the method 1100 may be implemented and performed by a device or its components, such as a base station 102, e.g., gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 1102, the method may include configuring cross-carrier scheduling information including a physical downlink control channel (PDCCH) to schedule sidelink transmission for a plurality of sidelink carrier frequencies. The operations of 1102 may be performed in accordance with examples as described herein. In some implementations, aspects of the operations of 1102 may be performed by a device as described with reference to FIG. 1.

At 1104, the method may include transmitting the cross-carrier scheduling information to a UE. The operations of 1104 may be performed in accordance with examples as described herein. In some implementations, aspects of the operations of 1104 may be performed by a device as described with reference to FIG. 1.

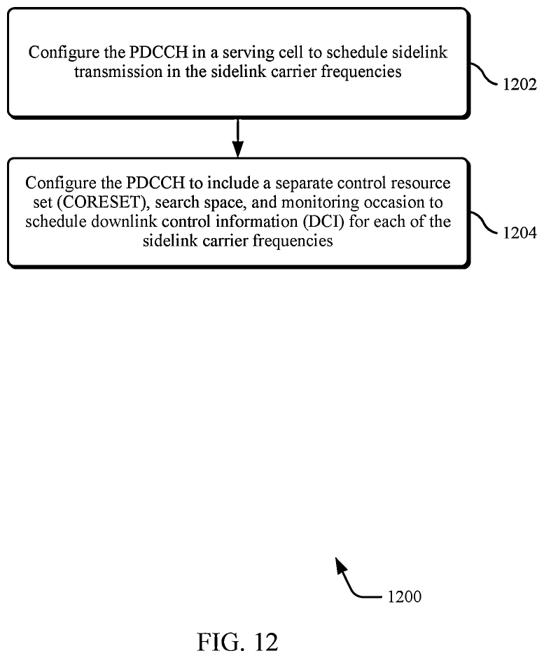

FIG. 12 illustrates a flowchart of a method 1200 that supports CA for sidelink communication in accordance with aspects of the present disclosure. The operations of the method 1200 may be implemented and performed by a device or its components, such as a base station 102, e.g., gNB as described with reference to FIGS. 1 through 3. In some implementations, the device may execute a set of instructions to control the function elements of the device to perform the described functions. Additionally, or alternatively, the device may perform aspects of the described functions using special-purpose hardware.

At 1202, the method may include configuring the PDCCH in a serving cell to schedule sidelink transmission in the sidelink carrier frequencies. The operations of 1202 may be performed in accordance with examples as described herein. In some implementations, aspects of the operations of 1202 may be performed by a device as described with reference to FIG. 1.

At 1204, the method may include configuring the PDCCH to include a separate control resource set (CORESET), search space, and monitoring occasion to schedule DCI for each of the sidelink carrier frequencies. The operations of 1204 may be performed in accordance with examples as described herein. In some implementations, aspects of the operations of 1204 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first UE, comprising:
at least one memory; and
at least one processor coupled with the at least one memory and configured to cause the first UE to:
determine sidelink carrier frequencies that are available to implement carrier aggregation (CA) for sidelink communication;
identify from the sidelink carrier frequencies at least one primary sidelink carrier frequency and at least one secondary sidelink carrier frequency; and
transmit data to a second UE using the at least one primary sidelink carrier frequency and the at least one secondary sidelink carrier frequency.

2. The first UE of claim 1, wherein the sidelink carrier frequencies are identified based on one or more of cell-specific signaling received from a network node, UE-specific signaling received from a network node, or a pre-configuration of the UE.

3. The first UE of claim 1, wherein the sidelink carrier frequencies are configured in an ascending order of absolute radio-frequency channel number (ARFCN).

4. The first UE of claim 1, wherein the at least one processor is configured to cause the first UE to receive, from a network node, a mapping of one or more of the sidelink carrier frequencies to one or more service types that are operable to receive sidelink communication, wherein the mapping is based at least in part on priority information for the service types.

5. The first UE of claim 1, wherein the at least one processor configured to cause the first UE to determine the sidelink carrier frequencies based on an association of a serving cell of the UE to the sidelink carrier frequencies.

6. The first UE of claim 5, wherein the association of the serving cell of the UE to the sidelink carrier frequencies is the same as an association of a primary cell of the UE to the sidelink carrier frequencies.

7. The first UE of claim 1, wherein the at least one processor is configured to cause the first UE to:
receive signaling comprising one or more sidelink carrier frequencies associated with one or more synchronization signal blocks (SSBs); and
receive the one or more SSBs over the one or more sidelink carrier frequencies for synchronization of the at least one primary sidelink carrier frequency and the at least one secondary sidelink carrier frequency.

8. The first UE of claim 7, wherein the one or more sidelink carrier frequencies associated with the one or more SSBs comprise the at least one primary sidelink carrier frequency.

9. The first UE of claim 1, wherein the sidelink carrier frequencies are identified based on UE-specific signaling received from a network node, and wherein the UE-specific signaling, and wherein the UE-specific signaling comprises one or more of:
configuration for one or more sidelink synchronization carrier frequencies;
one or more priority values for the sidelink carrier frequencies; or
mapping information for mapping the sidelink carrier frequencies to the sidelink synchronization carrier frequencies.

10. A first UE, comprising:
at least one memory; and
at least one processor coupled with the at least one memory and configured to cause the first UE to:
receive cross-carrier scheduling information comprising a scheduling physical downlink control channel (PDCCH) carrying scheduling for downlink control information (DCI) received on a first carrier frequency with a first subcarrier spacing, and a physical sidelink shared channel (PSSCH) carrying scheduling for sidelink transmission to a second UE on a second carrier frequency with a second subcarrier spacing; and
receive the PSSCH based on whether the first subcarrier is spacing is larger than or smaller than the second subcarrier spacing.

11. The first UE of claim 10, wherein the first subcarrier spacing and the second subcarrier spacing comprise orthogonal frequency-division multiplexing (OFDM) spacings for the first carrier frequency and the second carrier frequency, respectively.

12. The first UE of claim 10, wherein when the first subcarrier spacing is less than the second subcarrier spacing, the UE receives the PSSCH if a first symbol in a PSSCH allocation as defined by a time gap field in the DCI, and a first symbol of a slot of the PSSCH transmission start at least N PDCCH symbols after an end of the PDCCH scheduling of the PSSCH.

13. The first UE of claim 12, wherein the at least one processor is configured to cause the first UE to determine whether the first symbol in the PSSCH allocation as defined by the time gap field in the DCI, and the first symbol of the slot of the PSSCH transmission start at least N PDCCH symbols after the end of the PDCCH scheduling of the PSSCH independent of a receive timing difference between a scheduling cell and the second carrier frequency.

14. The first UE of claim 12, wherein the N PDCCH symbols are preconfigured in a table.

15. The first UE of claim 12, wherein the time gap field comprises a slot offset between the DCI and a start of the sidelink transmission.

16. A network node, comprising:
at least one memory; and
at least one processor coupled with the at least one memory and configured to cause the network node to:
generate a notification of sidelink carrier frequencies that are available to implement carrier aggregation (CA) for sidelink communication, the notification indicating at least one primary sidelink carrier frequency and at least one secondary sidelink carrier frequency; and
transmit the notification to a user equipment (UE).

17. The network node of claim 16, wherein the at least one processor is configured to cause the network node to generate the notification as one or more of cell-specific signaling or UE-specific signaling.

18. The network node of claim 16, wherein the notification identifies the sidelink carrier frequencies based on index values for the sidelink carrier frequencies in an index of sidelink carrier frequencies.

19. The network node of claim 16, wherein the notification identifies the sidelink carrier frequencies based on respective absolute radio-frequency channel numbers (ARFCNs) for the sidelink carrier frequencies.

20. (canceled)

21. A processor for wireless communication, comprising:
at least one controller coupled with at least one memory and configured to cause the processor to:
determine sidelink carrier frequencies that are available to implement carrier aggregation (CA) for sidelink communication;
identify from the sidelink carrier frequencies at least one primary sidelink carrier frequency and at least one secondary sidelink carrier frequency; and
transmit, from a first user equipment (UE), data to a second UE using the at least one primary sidelink carrier frequency and the at least one secondary sidelink carrier frequency.
